(19) United States
(12) Patent Application Publication
(10) Pub. No.: US 2009/0158920 A1
(43) Pub. Date: Jun. 25, 2009

(54) SOUND PRODUCING DEVICE WHICH USES PHYSIOLOGICAL INFORMATION

(76) Inventor: Yoshikazu Itami, Tokyo (JP)

Correspondence Address: MCNEELY BODENDORF LLP, P.O. BOX 34175, WASHINGTON, DC, 20043, US

(21) Appl. No.: 12/339,280

(22) Filed: Dec. 19, 2008

(30) Foreign Application Priority Data
Dec. 20, 2007 (JP) JP2007-329018

(51) Int. Cl. G10H 7/00

(52) U.S. Cl. 84/645

(57) ABSTRACT

To provide a sound producing system using physiological information to create sound outputs based on the user's physiological data, without individual differences between human instructors who provide the instructions for human movement, by using sounds that regulate human movement by machine. A sound system using physiological information comprising: a plurality of sensors that acquire physiological data, a MIDI device for producing sound information, a control unit that combines digital voice file data, sensor information, and sound information to control the output from speakers.

### FIELD OF THE INVENTION

This disclosure relates to an audio information output system about music, narration, and rhythm etc using physiological information which can be received from human body via sensors of respiration, pulse rate, blood pressure, and brainwave etc.

### BACKGROUND

This section provides background information related to the present disclosure which is not necessarily prior art.

The cost to treat an illness after it has been contracted is significantly higher than the cost of prevention. There are a variety of methods for maintaining and promoting health, but it is said that exercise is one of the most effective method. On the other hand, exercise-related accidents frequently occur due to improper exercise. In order to solve this problem, it is necessary to provide appropriate exercise instructions based on an individual's physical fitness and exercise experience, but it is difficult to base a solution solely upon the knowledge and perceptions of the individual who is exercising. For that reason, it is necessary for those who specialize in exercise instruction to provide advice appropriate to the physical fitness of the individual. However, due to problems such as time and cost, not everyone can receive exercise instructions. Therefore, today it has become increasingly common for health maintenance and promotion to be carried out with computers and exercise assistance devices (for example, refer to Patent Documents 1 and 2).

Patent Document 1 is a Japanese Unexamined Patent Application with the Publication No. 2007-75172.

Patent Document 2 is a Japanese Unexamined Patent Application with the Publication No. 2007-193908. Both Patent Documents 1 and 2 are incorporated herewith by reference.

Embodiments of the present invention create effective audio exercise instructions using sound so that users can appropriately use these exercise devices. Embodiments of the present invention elaborate on the audio function for effective exercise instructions installed in exercise assistance devices.

### SUMMARY

This section provides a general summary of the disclosure, and is not a comprehensive disclosure of its full scope or all of its features.

In order to provide effective exercise instruction, and in order to provide instructions on bodily movement for the purpose of making accurate physical measurements, it is necessary to measure the exerciser's physical data in real time and provide instructions based on these measurement results.

In instructing people on movement, there is information gained from the eyes, ears and information provided directly to the body, but today the easiest method is to use sound. However, that instruction is the word based on the experience and perceptions of the instructor, or the sound from a machine, so it does not necessary mean that the appropriate sound was used for the instructions.

Also, the method of instructing based on experience and perceptions by human being is not consistent among instructors, resulting in a variety of instructions.

Embodiments of the present invention focus on these problems, and by using sound which regulates human movement by machine, create audio output based on the exerciser's physiological data, without individual differences between human instructors who provide the instructions for human movement.

In order to solve the problems, an embodiment of a sound producing system using physiological information comprises:

a plurality of sensors that acquire physiological information, a MIDI device for producing audio information, and a control unit that combines digital sound file data, sensor information and audio information to control the output from speakers.

An embodiment of the sound producing system using physiological information comprises:

a sound source for producing the audio information uses a MIDI device using at least two-track that primarily produces music and rhythm, and a sound source that digitally records human voice.

According to an embodiment of the sound producing device using physiological information:

the audio output consists of at least three types of sounds: music, rhythm, and voice, the output of the music and rhythm is the audio output that uses MIDI notes, and the voice is played back with recorded voice.

An embodiment of the sound producing device using physiological information further comprises:

comparing with the numerical range prepared in advance to determine whether the physical state is appropriate, and in order to create an appropriate physical state by using the sound, it initially uses the output speed of a MIDI sound which has an audio output instructing physiological information that is lower than the target numerical range, and then the speed is incrementally increased, and when the target numerical range is reached, the function that incrementally increases the speed is ceased, and the output speed at the time that the numerical range is reached will be maintained.

According to an embodiment of the sound producing system using physiological information:

the output of voice data differs by the voice data selected in accordance with the physiological information acquired by the sensors, and the voice data is divided into several states: the intermediate area of the setting range, the lower area of the setting range, the upper area of the setting range, the area below the lower setting range, and the area above the upper setting range.

According to an embodiment of the sound producing device using physiological information:

the audio output is stopped in the event that the measured physiological information was not reached in the setting range even if the audio output speed is increased within a specified period of time.

Further areas of applicability will become apparent from the description provided herein. The description and specific examples in this summary are intended for purposes of illustration only and are not intended to limit the scope of the present disclosure.

### BRIEF DESCRIPTION OF THE DRAWING(S)

The drawings described herein are for illustrative purposes only of selected embodiments and not all possible implementations, and are not intended to limit the scope of the present disclosure.

FIG. 1 is a descriptive illustration of the sound producing device.

FIG. 2 is a descriptive illustration of the sound producing device.

FIG. 3 is a descriptive illustration of the control state of the audio output timing.

FIG. 4 is a descriptive illustration of the control state of the volume control.

FIG. 5 is a descriptive illustration of the control state of the music and rhythm output speed.

FIG. 6 is a descriptive illustration of the control state of the narration output information.

FIG. 7 is a descriptive illustration of the sound producing device.

FIG. 8 is a descriptive illustration of the control state of the rhythm and music.

FIG. 9 is a descriptive illustration of the control state of the sound producing device using the brainwave measuring device.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The best modes for carrying out the sound producing device using physiological information relates to embodiments of the present invention are explained below:

In one embodiment, a sound producing device (audio information output system), includes a plurality of sensors that acquire physiological data, a MIDI device for producing audio information, and a program that regulates whether digital voice file data, sensor information, and audio information is combined and outputted from speakers.

The sensors differ from each other depending on what they are measuring such as respiration, heartbeat, brainwave activity or blood pressure. Although appropriate sensors are selected, the audio source for producing sound primarily utilizes the audio source which digitally records MIDI using two tracks that produce the music and rhythms, and the human voices. (Refer to FIG. 1)

In selecting sound, by comparing with the threshold value of appropriate range previously forecasted, it selects the output sound after determining whether the information acquired from the sensors is above, below, or within the threshold value. The output speed of MIDI music produced by digital notes in combination with a MIDI audio source is determined based on the measurement information acquired from the person's body.

Similarly, the output speed of MIDI rhythm produced by digital notes in combination with a MIDI music source is determined based on the measurement information acquired from the person's body.

The time axis of the output speed is the same for the music track and the rhythm track, and a software selects whether the output will be one of the music, rhythm, or both.

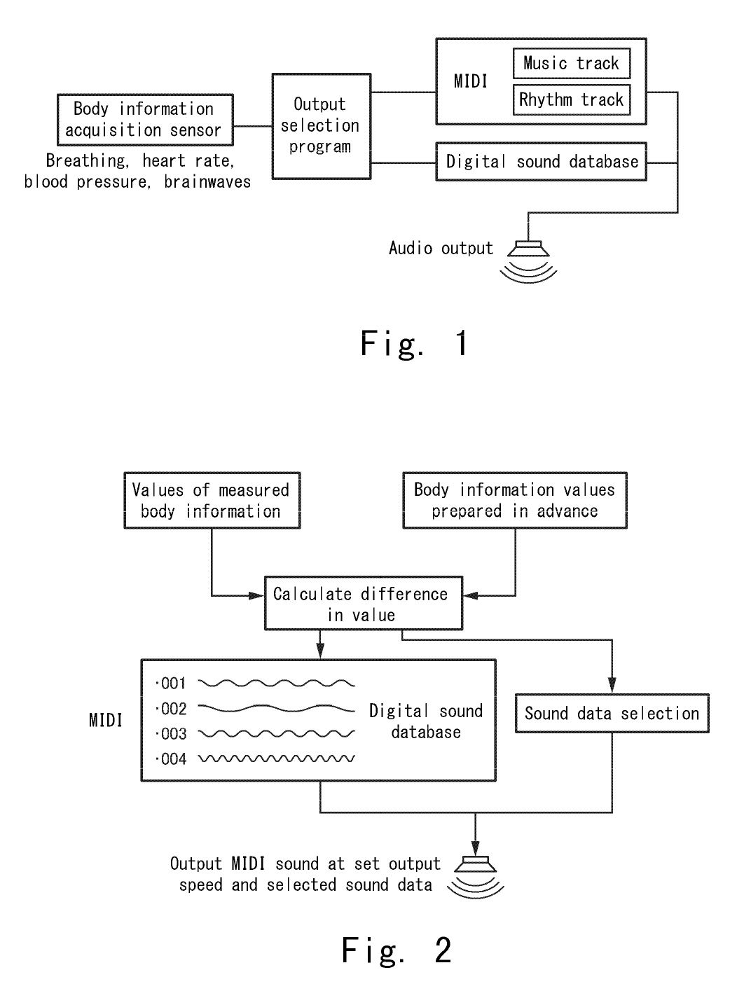

Sound selection from the digital voice database is carried out so that different IDs are attached to a plurality of voice data registered in the digital voice database respectively. It compares the status of the physiological information incorporated in the voice output control program with the physiological information previously prepared, and outputs the target voice from the differences between the two (Refer to FIG. 2).

According to this feature, if physiological information acquired from the body by using sensors is transmitted to the audio selection function, the voice data based on the physiological information and the music output speed, as well as the rhythm output speed will be selected and outputted.

Annotation: MIDI is an abbreviation for “Musical Instrument Digital Interface.”. This is the standard of data format, protocol, and physical interface used in electronic musical instruments such as synthesizers.

MIDI data possesses time concepts such as “bar” and “beat,” and can record music notation information such as which key to press, what position to press it in, and with what timing in that scale. In other words, MIDI data can be said to be the music book for electronic instruments.

Also, it handles various data pertaining to controlling the instrument, such as tone selection for each part, “pan” (position left or right), and the degree of effects such as reverberation and chorus.

Combining Music, Narration, and Rhythm

The sound output includes music, rhythm, and voice, and the music and rhythm is the sound output using MIDI notes, and the voice is reproduced using a recorded voice.

The music and rhythm output speed control uses the same program, and the sound output is at the same music note position by same speed. The output control program determines the output speed of the music and rhythm, and then outputs the sound. As for the voice, by comparing the threshold value set in advance with the physiological information obtained by using sensors, the voice data selected based on this result is outputted.

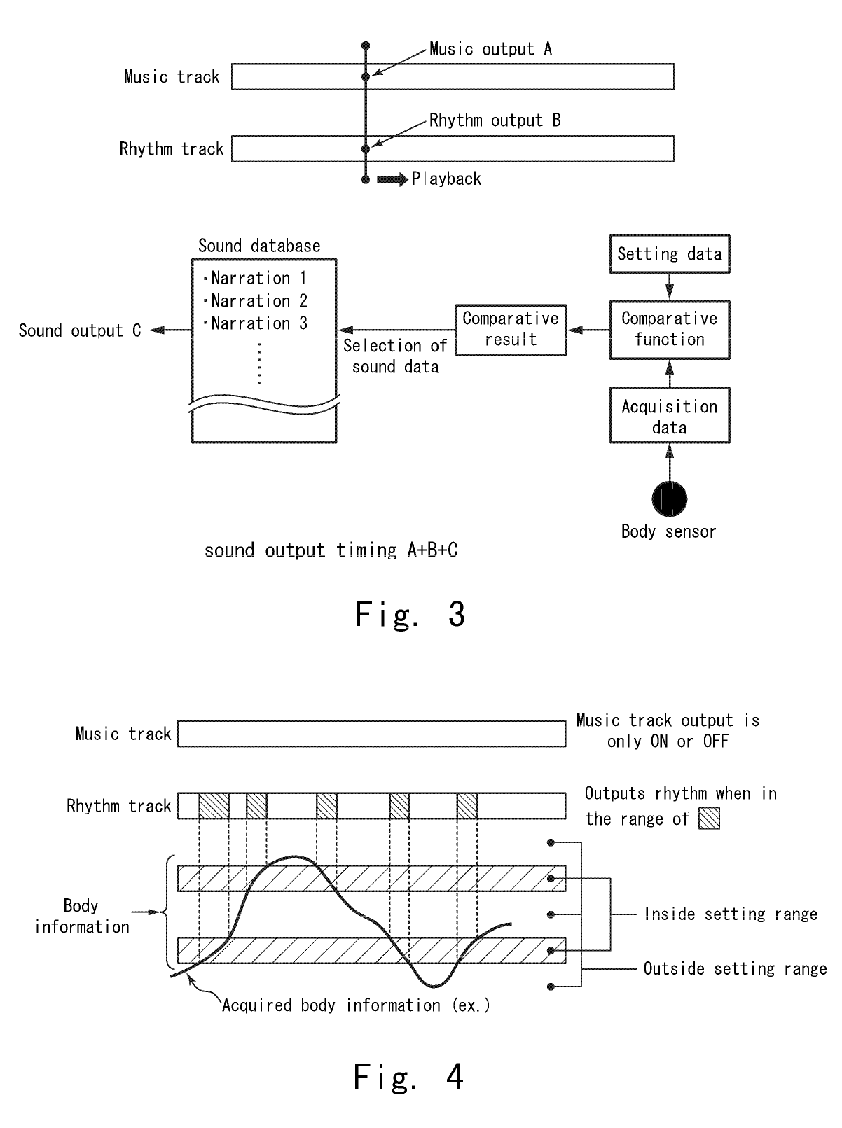

In this manner, this embodiment is carried out by using a combination of MIDI sounds that the output speed is regulated by the program, and voice outputs is decided by comparing the threshold value set in advance with the physiological information (Refer to FIG. 3).

Two-Channel MIDI Volume Control

Music and rhythm, the two types of sounds output from a MIDI, can be outputted either only in single track or simultaneously according to the user's selection. Also, the rhythm track can be outputted only when the setting range of physiological information set in advance is reached. The music track, regardless of the threshold values, is set to ON and OFF (Refer to FIG. Four).

Adjusting the Output Speed of the Music and Rhythm

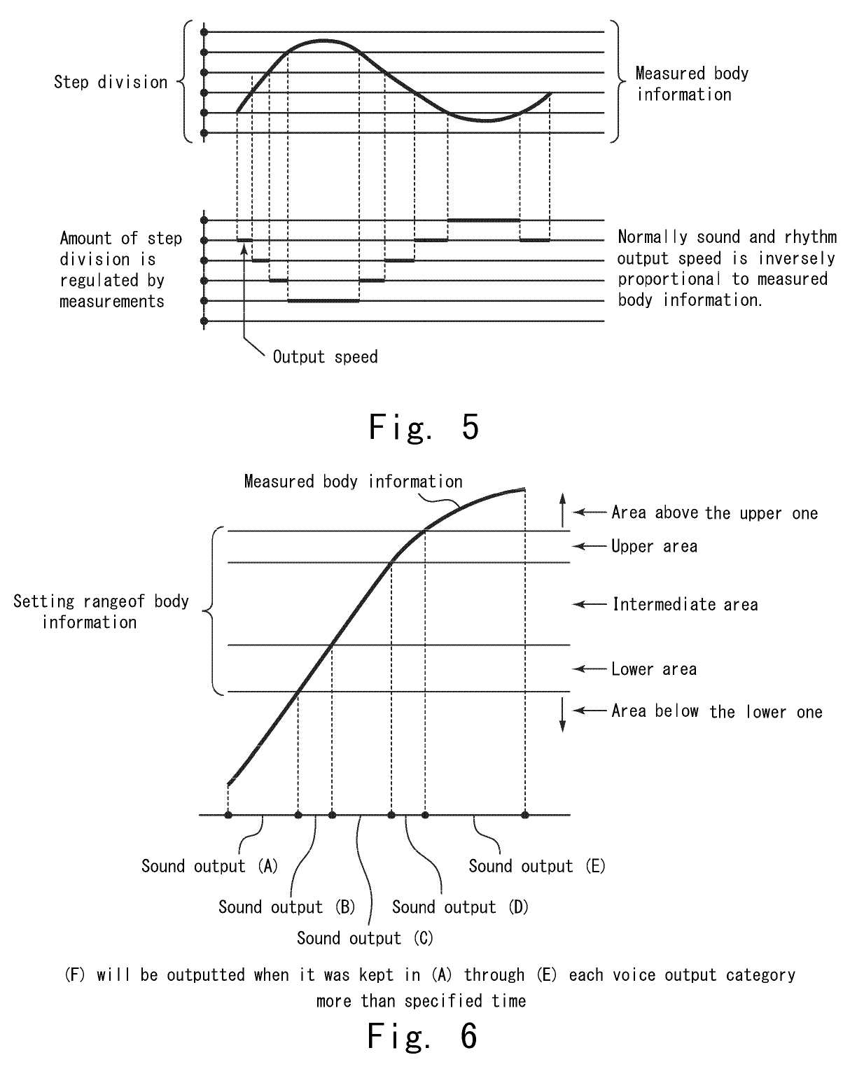

The output speed of the music and rhythm is determined by comparing the physiological information obtained from the sensors with the threshold values set in advance, but human physiological information always varies slightly, if the information is used as-is to regulated the output speed of the music and rhythm, the output music and rhythm will always sound like unstable music, causing psychological stress for the listener. In order to solve this problem, the music output is modified by dividing it into steps (The quantity of the divided step is determined by the contents of the physiological information measurements). (Refer to FIG. 5).

Functions that Guide for Keeping Measured Physiological Information in the Setting Range

In order to obtain effective measurement results by keeping the measuring physiological information in the setting range, an embodiment of the present invention modifies the sound output based on the position of the measured value relative to the setting range. When the measured value is in the intermediate area of the setting range, the output speed of the MIDI sound does not change and the output speed at that point will be maintained.

When the measured value is in the lower range of the setting range, the output speed of MIDI sound will be stepped up and the sound speed which increases the measured value to the intermediate area of the setting range will be outputted.

When the measuring value is in the upper range of the setting range, the MIDI output speed will be stepped down and the sound speed which decreases the measured value to the intermediate range will be outputted, and there is sound guide function which always keeps the measured physiological information within the setting range.

Warm-Up Step-Up Output

People who will obtain their physiological information attach sensors to their bodies, and sometimes it takes time for obtaining the physiological information properly. Also, there are instances where the physical condition is such that proper physiological information cannot be obtained even after time has elapsed. In order to solve this problem, an embodiment of the present invention has a function that uses sound to guide the user into an appropriate physical condition.

In order to determine whether the physical condition is appropriate, a comparison is made with the previously prepared numerical range. In order to use sound to attain an appropriate physical condition, a MIDI sound output speed which has the audio output guiding the physiological information that is lower than the target numerical range that is initially used. The output speed is incrementally raised, and at the stage where the target numerical range is reached, it ceases the function of incrementally increasing the output speed and maintains the output speed at the point where the numerical range is reached.

Cooling-Down Step-Down Output

After the people who will obtain their physiological information attach sensors to their bodies and the physiological information is appropriately obtained, if the measurements are suddenly stopped, it may physically burden the user. In order to solve this problem, it guides by using sound over a period of time to return the body back to a rested condition from the condition when the body was being measured.

In order to determine whether the body is at a rested state, it compares the physiological information with that taken before the warm-up guidance, and determines whether the information falls within the range set in advance. In order to use sound to put the body into a rested condition, the output speed is incrementally lowered from the audio output speed created due to the results of the present measurements, and the MIDI output speed is not lowered until the range of rested body condition set in advance is reached, when the target numerical range is reached, the cooling-down step-down output using MIDI sound will be ceased.

Method of Selecting Narration Output Information

As for the voice data output, the selected voice data differs according to the information acquired from the body by using sensors.

The voice data is divided into five levels: the intermediate area of the setting range, the lower area of the setting range, the upper area of the setting range, the area below the lower setting range, and the area above the upper setting range.

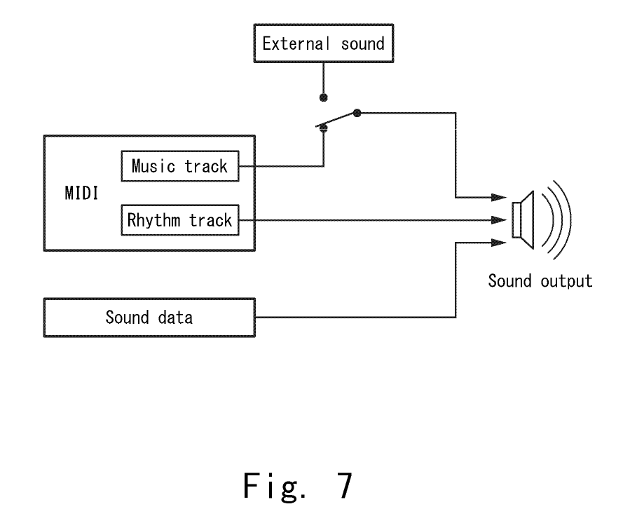

Also, in each of the divided ranges, the selected voice output will differ based on how much of time measurement results stay in each category. Voice output data is selected by using the classification method below (Refer to FIG. 6):

1. The intermediate area of the setting range;

2. The lower area of the setting range;

3. The upper area of the setting range;

4. The area below the lower setting range;

5. The area above the upper setting range;

6. Selection criterion based on the time kept in each category.

Safety Features

In the event that the measured value from the sensors does not reach the target range within a specified period of time, the audio output and measurement operations will stop. An embodiment of the present invention is programmed to place the measured values from the body into the setting range. In order to accomplish this, the audio output speed does not increase until it enters the setting range, but if the measured physiological information does not reach the setting range within a specified period of time even if the audio output speed is increased, a danger will be detected and it will be shifted to a program that ceases the sensor measurements and audio output.

Even if the setting range used in this invention varies from a fixed value, the function will be maintained. The setting range for physiological information can be modified according to physical conditions of the user or the purpose of the user, but the combination of music, narration, and rhythm, the output speed adjustment of the music and rhythm, and the method for selecting the narration output data does not change. The step dividing quantity for adjusting the output speed of the music and rhythm; and the upper area value, intermediate area value, and lower area value in method for selecting the narration output information are different.

MIDI Sound and the Voice Output Volume Control

Sometimes the audio output from this invention is a simultaneous output of MIDI sound and voice data. In these situations, one problem is that the output sound of voice information becomes difficult to hear. In order to solve this, while voice information is being outputted, the output volume of the MIDI sound is decreased, and when the voice information output is ceased, the output volume of the MIDI sound is automatically returned to its original level.

Structure in Situations Where Pulse Information is Used

The setting range for the physiological information is determined by using a pulse sensor, as well as age information of user and the information obtained from a questionnaire filled out by the user.

Initially, the warm-up, step-up output will be implemented. While effectively regulating pulse rate by using MIDI sounds of exercise speed and (exercise strengthening) and voice output, it will use the function for guiding the measured physiological data previously mentioned into the setting range and, using sound to guide the pulse rate so that it stays within the target setting range.

When the pulse rate is kept in the setting range within a specified time, it will implement the cool-down, step down output previously mentioned and end the exercise instruction program using pulse data.

Structure When Respiration Information is Used

The setting range for physiological information will be determined by using respiration information obtained from the pulse sensors and information obtained from a questionnaire filled out by the user.

Firstly, the warm-up, step-up output previously mentioned will be implemented. While effectively regulating the respiration timing, length, and amount following the audio guide by using MIDI sounds of exercise speed and (exercise strengthening) and voice output, using the function that guides the measuring physiological information and keeps it within the setting range, the guidance using sound is provided so that the amount of oxygen intake and respiration timing falls within the target setting range.

When the amount of oxygen intake and respiration timing is kept in the setting range within a specific time, it will implement the cool-down, step-down output previously mentioned, and end the exercise instruction program using respiration information.

Structure When Blood Pressure Information is Used

The setting range for physiological information will be determined by using blood pressure information of user obtained from blood pressure sensor and information obtained from a questionnaire filled out by the user.

This will be used when the user becomes mentally unstable accompanied by a change in blood pressure.

Initially, the warm-up, step-up output previously mentioned will be implemented. The blood pressure of users will be kept in the intended range by regulating their breathing following the audio guide and effectively controlling the timing and length of their respiration, using the MIDI sound exercise speed and (exercise strengthening) and the voice output.

In order to achieve this, using the function that guides the measured physiological information so that it stays in the setting range, and respiratory timing and length are guided by sound in order to keep them within the target setting range.

Structure When Brainwaves Information are Used

The method is to guide the user's brainwave state into the setting range using brainwave sensors. Using information from brainwave measurements (any one of the four types which is δ (delta) waves, θ (theta) waves, α (alpha) waves, and β (beta) waves, or a combination thereof), it provides the audio output speed and audio output for inducing sleep or mental unity.

Initially, the warm-up, step-up output previously mentioned is implemented. Using audio speed by MIDI sound and audio output, it effectively induces sleep or mental unity.

In order to achieve this, using the function that guides the measured physiological information so that it stays in the setting range, and respiratory timing and length are guided by sound in order to keep them within the target setting range.

In order to increase safety and effectiveness, this invention supplies sound to only one ear. By providing sound to only one ear, the external sounds can be heard. Due to this, if it were to be used outside, not only would the user be able to detect danger in advance, by hearing other sounds, more effective sound instruction can be implemented. It will be effective when that even if the user is wearing the device of this invention and their physiological information is being regulated, the built-in audio information is still insufficient, and the instruction using external sound is provided.

This invention accepts external inputted sound besides the built-in MIDI sound and voice data.

When external sound is inputted into this system, the sound from the MIDI music track is automatically cut, and external inputted sound is outputted from speakers. Even in the event that externally inputted sound is accepted, it does not affect the output of the MIDI sound or the voice data. The ON/OFF control for externally inputted sound uses a mechanical switch (Refer to FIG. 7).

Composition of Rhythm and Music Sound as Four Beats Equaling One Unit

The composition of the rhythm and music sounds incorporated inside the MIDI is standardized at 1 sound=0.25 seconds, and the four 0.25 second sounds are combined sequentially, creating a rhythm block with a total of four sounds, two seconds, and one unit. This is produced continuously.

One beat equals 0.25 seconds, 4 beats equal one unit, and music that has a total of two seconds of output speed is equivalent to 120 bpm, it is an audio output speed that will effectively boost heart and lung function, and is the minimum audio output speed to mentally arouse the user.

The music recorded on the music track will also use music that can be divided and the unit is four beat. Therefore, the sound output structure that even if the music and rhythm are repeatedly played back at the same time, there will be no lag in the rhythm due to the repeated play back will be provided.

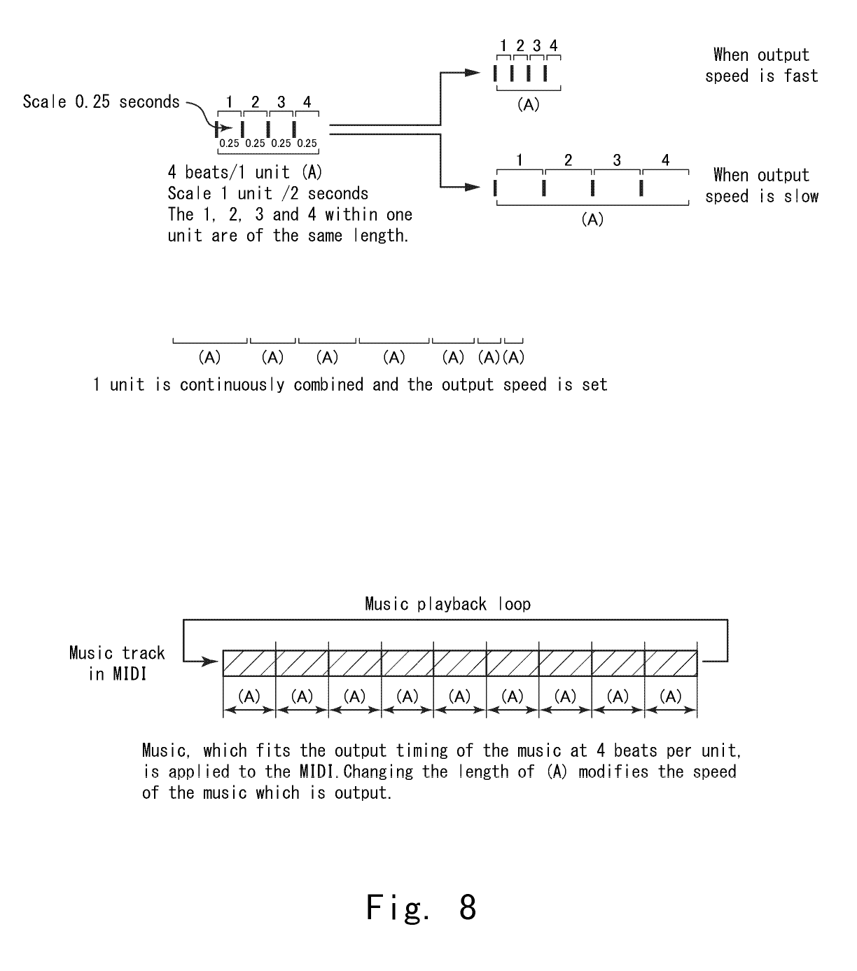

When editing the speed of the MIDI audio output, the audio output speed is changed by adjusting the four-beat playback interval. In this case, it utilizes a technology that shortens or lengthens the four-beat output interval at the same interval; it reduces awkwardness in the output music (Refer to FIG. 8).

Application

For exercise instruction that will increase heart and lung function, it acquires pulse information from the pulse sensor, outputs a sound related to that information, and conducts exercise instruction for raising heart and lung function using that sound.

MIDI sounds are used as an exercise pacemaker to keep the pulse rate within the threshold setting range. The MIDI music track, combined with the music output speed, adjusts the music output speed, making the output speed correspond to the pulse information measurements so that the pulse rate stays within the intended range. This is used as an exercise pacemaker. When the pulse rate approaches the upper or lower intended pulse range, or is not in that intended pulse rate range, the MIDI rhythm track changes the output speed of the four-beat rhythm sounds in order to force the pulse rate back to the intended range using rhythm sounds. The voice output will provide varying voice outputs which set respectively in the event that the physiological information acquired by the sensors outside the threshold range is within the threshold range, also when it approaches being outside the threshold range, when it exceeds the threshold value, or when it does not fall inside the threshold value to the user. It will conduct exercise instruction by sound so that the user can obtain effective exercise strengthening in order to increase heart and lung function, as well as pulse rate during the exercise.

A device that guides the control of the speed and strength of respiration for stabilizing the psychological state.

Using a respiration sensor, the degree of psychological instability can be estimated by measuring the timing and length of respiration, as well as the amount of oxygen taken in. The degree of psychological instability will be compared to a previously set threshold value, and it provides guidance on effective breathing methods that will lead to psychological stability using the music output speed, the rhythm output speed, and voice.

Device to Guide Breathing During Childbirth

A device that in addition to being able to alleviate the psychological and physical pain of pregnant woman during childbirth using effective breathing techniques, and also is effective in stimulating an easier childbirth.

It calculates the respiratory state of the user using a respiration sensor. The calculated respiratory state (respiratory timing, respiratory length, respiratory strength) is compared to a respiratory range previously set, and based on the position of the respiratory measurement information, the output of MIDI music, rhythm, and voice information is modified, guiding the user to a previously set appropriate respiratory range.

Device for Hyperventilation Therapy

A device that in addition to using effective respiration techniques to alleviate the psychological and physical pain of hyperventilation, and also is effective in treating hyperventilation.

It calculates the respiratory state of the user using a respiration sensor. The calculated respiratory state (respiratory timing, respiratory length, respiratory strength) is compared to a respiratory range previously set, and based on the position of the respiratory measurement information the output of MIDI music, rhythm, and voice information is modified, guiding the user to a previously set appropriate respiratory range.

Device that Stabilizes the Risen Blood Pressure Psychologically

A setting range for physiological information is determined using blood pressure information obtained from a blood pressure sensor and information gathered from a user questionnaire, and a comparison is made between the setting range and the measured blood pressure. Using effective sound output timing and a voice guide, the user's blood pressure is lulled into that of a rested state.

In the event that there is a rapid rise in blood pressure to mental excitement, users with heart problems may significantly damage their hearts trying to maintain a healthy state. In order to solve this problem, the blood pressure information obtained from the blood pressure sensor is compared with the setting range, and in order to draw the blood pressure to the target setting range, suitable music and rhythm speed factors, and voice are determined by using the blood pressure, MIDI music and rhythm output speed function.

Sleep Inducing Device that Uses Brainwave Measurements

Using a brainwave measurement device,

δ (Delta) Waves (0.5-4 Hz) appear when one is sound asleep;

θ (Theta) Waves (4-8 Hz) appear when one has become sleepy;

α (Alpha) Waves (8-13 Hz) appear at the part of brain which is resting;

β (Beta) Waves (13-40 Hz) extract phenomena that appear at the part of brain which is mentally active.

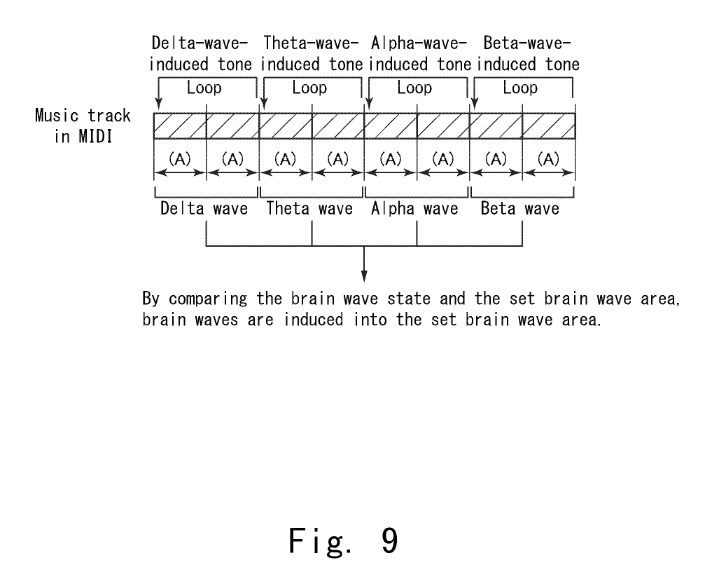

It will induce theta waves and delta waves from the extracted brainwave information and induce sleep with MIDI music output, its playback speed, and voice. The content of the music output induces theta waves and delta waves selecting the tone and speed which will induce sleep matching the measured right-wave state, using music that contains multiple tones that consist of music that can be divided into four beats per unit (Refer to FIG. 9).

Mental Concentration Inducement Device for Zen Meditation that Uses Brainwave and Pulse Data

Using a brainwave measurement device:

δ (Delta Waves) (0.5-4 Hz) appear when one is sound asleep;

θ (Theta Waves) (4-8 Hz) appear when one has become sleepy;

α (Alpha Waves) (8-13 Hz) appear at the part of brain which is resting;

β (Beta Waves) (13-40 Hz) extract phenomena that appear at the part of brain which is mentally active.

It will induce beta waves from the extracted brainwave information and induce sleep with MIDI music output, its playback speed, and voice. The content of the music output induces theta waves and delta waves selecting the tone and speed which will induce sleep matching the measured right-wave state, using music that contains multiple tones that consist of music that can be divided into four beats per unit (Refer to FIG. Nine).

Posture Guidance Device that Uses a Position Information Sensor

The position information sensor detects the position and amount of movement of the part attached to the body as well as the direction of movement. The information in a database which contains previously set information ranges are divided into classes, and the measured data is compared to the data divided into classes. It has a voice guide function that regulates posture in the walking, standing, and sitting positions using an audio output speed, a rhythm output speed, and voice output corresponding to that class which includes measured data.

Body Balance Guiding Device which Uses a Balance Sensor

It detects the difference in weight placed on the multiple weight and position sensors, and position sensors installed in special parts detect the position of that part and amount of movement in that position as well as the direction of the movement. The information in the database that contains the previously set information range is divided into classes, and the measured data is compared to the data divided into classes. With music output speed, rhythm speed, and voice output corresponding to a class that includes measured data, it detects differences between setting positions from each part of the body and in addition to generating voice output to correct this, and it also outputs the music contains exercise strengthening and rhythm for correcting balance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sound producing device using physiological information, comprising:
a plurality of sensors that acquire physiological information,
a MIDI device for producing audio information, and
a control unit that combines digital sound file data, sensor information and audio information to control the output from speakers.

2. The sound producing device using physiological information according to claim 1, further comprising:
a sound source for producing audio information uses a MIDI device using at least two-track that primarily produces music and rhythm, and
a sound source that digitally records human voice.

3. The sound producing device using physiological information according to claim 1, wherein the audio output comprises at least three types of sounds: music, rhythm, and voice;
the output of the music and rhythm is the audio output that uses MIDI notes; and
the voice is played back with recorded voice.

4. The sound producing device using physiological information according to claim 1, wherein the device performs:
comparing with the numerical range prepared in advance to determine whether the physical condition is appropriate;
in order to create an appropriate physical condition by using the sound, initially using the output speed of a MIDI sound which has an audio output instructing physiological information that is lower than the target numerical range, and then incrementally increasing the speed; and
when the target numerical range is reached, ceasing a function that incrementally increases the speed, and maintaining the output speed at the time that the numerical range is reached.

5. The sound producing device using physiological information according to claim 1, wherein the output of voice data differs by the voice data selected in accordance with the physiological information acquired by the sensors, and the voice data is divided into several states: the intermediate area of the setting range, the lower area of the setting range, the upper area of the setting range, the area below the lower setting range, and the area above the upper setting range.

6. The sound producing device using physiological information according to claim 4, wherein the audio output is stopped in the event that the measured physiological information is not reached in the setting range even if the audio output speed is increased within a specified period of time.
